(19) United States
(12) Patent Application Publication
(10) Pub. No.: US 2016/0208944 A1
(43) Pub. Date: Jul. 21, 2016

(54) DIELECTRIC ELASTOMER VALVE ASSEMBLY

(71) Applicant: PARKER-HANNIFIN CORPORATION, Cleveland, OH (US)

(72) Inventors: Arthur H. Muir, San Mateo, CA (US); Silmon James Biggs, Los Gatos, CA (US); Roger Nelson Hitchcock, San Leandro, CA (US)

(21) Appl. No.: 14/912,960

(22) PCT Filed: Oct. 3, 2014
(86) PCT No.: PCT/US2014/059123

§ 371 Date: Feb. 19, 2016

Related U.S. Application Data
(60) Provisional application No. 61/886,151, filed on Oct. 3, 2013.

(51) Int. Cl. F16K 31/02; F04B 43/14; F16K 7/14

(52) U.S. Cl. CPC F16K 31/02; F16K 7/14; F04B 43/14

(57) ABSTRACT

A fluid flow device that includes a backing structure, a compression element, and at least one actuator element adjacent the compression element such that the at least one actuator element is configured to compress the compression element towards the backing structure when the at least one actuator element is in a first state and the at least one actuator element is configured to allow a fluid to flow from an inlet to an outlet of a fluid passage based on deflection of the at least one actuator element.

### CROSS REFERENCE TO RELATED APPLICATIONS

This application claims the benefit of U.S. Provisional Patent Application Ser. No. 61/886,151, entitled “DIELECTRIC ELASTOMER VALVE ASSEMBLY”, filed on Oct. 3, 2013, the entire disclosure of which is incorporated herein by reference.

### TECHNICAL FIELD

The present disclosure is directed to the technical field of fluid passage members such as valves and pumps. In particular, the present disclosure is directed to valves and/or pumps that incorporate an electroactive polymer configured for controlling fluid flow through a fluid passage.

### BACKGROUND

In order to obtain fluid flowing through a flowing passage member, an external fluid pump is generally needed. The pump is generally coupled to a source of fluid and forces the fluid out at a prescribed rate through the fluid passage member. It is common in fluid systems to desire knowledge of the pressure of the fluid flowing through the system for maintaining system operating parameters within an acceptable range, detecting malfunctioning of products due to an abrupt pressure change, etc. Currently, many fluidic and pneumatic systems do not incorporate local fluid actuation system or pressure measurement capabilities.

Traditional peristaltic pumps are subject to several challenges including complexity, requiring multiple pressure rollers mounted on a moving rotor, and pressing against an adjustable surface with a variable speed motor and controls. The bulkiness and cost of such system often renders it undesirable for use in a number of applications, such as integrated or microfluidic chemical analysis systems such as labs-on-a-chip, where a peristaltic pump would otherwise be a good option. These applications would be well served by low cost, monolithic, low profile fluid control systems with integrated pumps, valves, and sensors. Similar devices and apparatus may be found in the publication of International Application No. PCT/US2012/056793, the entire disclosure of which is incorporated herein by reference.

Additionally, in a typical solenoid valve, in the closed position, a ferrous solenoid plunger bears on a diaphragm within the valve body to seal the fluid path. When energized, the solenoid plunger retracts off of the diaphragm, which in turn allows the restoring force of the diaphragm to flex the diaphragm face off of the sealing portion of the valve, allowing fluid to flow through the valve. Solenoid valves may not open or close at speeds that are desirable in specific application and may require higher energizing currents to move the ferrous plunger.

Further, the ubiquity of pumping and valve applications have led to a demand for cost-effective devices that are easy to manufacture. In addition, many of these applications require a pump or valve device that operates under specific threshold conditions and must be accurately controlled.

### SUMMARY

This disclosure provides fluid flow devices comprising at least one actuator member, an actuator backing structure attached to the at least one actuator member, a fluid passage member having an inlet and an outlet, and a passage member backing structure attached to the fluid passage member. In some embodiments, actuation of the at least one actuator member can be used to control or eliminate the flow rate of the fluid passing from the inlet to the outlet of the fluid passage member. In other embodiments, the devices may further comprise a plurality of actuator members which can be energized to pump fluid from the inlet to the outlet of the fluid passage member. In some embodiments, the at least one actuator member may comprise an Electroactive Polymer (“EAP”) transducer. In other embodiments, the EAP transducer can be used to sense the fluid flow or pressure at locations within the fluid flow device.

The present disclosure provides a peristaltic type of pump system. According to one embodiment, the peristaltic type of pump system is configured to leverage the inherent properties of EAP materials to create a novel mechanism for pumping gases, fluids, or slurries. Primary advantages of the present disclosure include: (1) No sliding or rolling parts and hence has very low friction, no frictional wear surfaces and none of the complexities of traditional mechanical peristaltic systems; (2) Quiet operation and can be easily scaled in size, making it suitable for multiple applications where traditional peristaltic systems may be a poor fit; (3) Delivery of very precise increments of fluid flow in either direction; and (4) The pumping mechanism can be made as part of an integrated, disposable delivery system that facilitates sterile environments useful in healthcare and some manufacturing processes.

In one embodiment, the only moving parts are EAP, combined with the flexing of the membrane and the delivery tube; there are no mechanical motors, gears or rollers. Unlike traditional pumps, with all actuators inactive, fluid can freely flow through the delivery tube if desired. The pump may be silent and compact since it has no motors or gear reduction systems. While other actuators, such as piezoelectric transducers, may be used in this invention, EAP transducers are preferred since they may be manufactured through low-cost, high volume processes traditionally used in the printed electronics industry facilitating the integration of multiple fluid flow devices in a small-footprint monolithic construction.

In one embodiment, the present disclosure provides an array of individually addressable EAP actuators, positioned on a backing structure so as to press up against a flexible delivery tube or a flexible membrane over the delivery tube. The flexible membrane may be manufactured from any materials that are appropriate for the application, such as for example, fiberglass and PET. The tube inlet is connected to the supply of material to be pumped, the tube exit connected to the delivery line or use point of the pumped material. The actuators are electrically activated in a peristaltic sequence to create a moving volume zone within the tube that moves doses of material through the delivery tube. The membrane provides enough stiffness so that a compression zone can be swept smoothly along the delivery tube in sequential waves. The restoring force of the delivery tube is used to counteract the compression force of the static EAP actuators. This restoring force may be augmented with elastic/spring devices positioned along the outside of the delivery tube to allow the use of thin wall delivery tube.

The present disclosure also provides an EAP valve mechanism that has minimal moving mass and uses the spring force of EAP as a preload to achieve the closing force needed to seal the valve. Pulse Width Modulation (“PWM”) signals may be used to achieve flow control with a solenoid valve, and desired higher valve cycle rates, that are unattainable with a ferrous solenoid plunger due in part to the inherent mass of the ferrous solenoid plunger.

In one embodiment, a stacked EAP actuator is mounted with a compressive pre-load, and a boss is affixed to the end of the stack, so as to apply pressure to the diaphragm and cause it to seal the fluid flow path or fluid passage. The EAP stack is configured to contract when energized; pulling the boss off of the diaphragm, allowing the diaphragm to flex off of the sealing portion of the valve, and thereby allowing fluid to flow through the valve. The actuator may be housed in a threaded compression cap module that can be unscrewed, facilitating replacement and adjustment of the pre-load during assembly. Additionally, the valve mechanism may use the preload of the actuator body to provide the force to hold the diaphragm closed. Furthermore, housing the actuator in a threaded compression cap facilitates replacement of the module and adjustment of the pre-load.

An EAP valve mechanism according to the present disclosure allows the valve to actuate more rapidly, which allows it to achieve a wider range of flow rates when used with a PWM scheme. Additionally, an EAP actuator may require less current than standard valves such as solenoid devices to open or hold the valve open. Further, a threaded compression cap facilitates replacement of the module and adjustment of the preload.

The present disclosure also provides a pressure relief valve and/or pump. Their mechanical performance of EAP actuators, such as a dielectric elastomer actuator, can be improved by at least partially cancelling the stiffness of the EAP actuator with a negative rate mechanism. While keeping an overall package size small, compact negative-rate spring designs can produce appropriate force. Beams or other configurations, such as a polymer Non-Linear dome spring, made of elastic materials, such as silicone polymer, at an appropriate thickness, with an appropriate cross-section profile can be used to accomplish the desired effect. Thick polymer flexures can provide spring rates equivalent to other materials while offering advantages, such as: (1) larger travel than other materials within the same footprint, (2) a larger safety factor due to the toughness of the polymer, and (3) thermal expansion coefficient matched to the silicone of the actuator itself.

### BRIEF DESCRIPTION OF THE DRAWINGS

The novel features of the various embodiments are set forth with particularity in the appended claims. The various embodiments, however, both as to organization and methods of operation, together with the advantages thereof, may be understood by reference to the following description taken in conjunction with the accompanying drawings as follows.

FIGS. 1a and 1b are schematic illustrations of an electroactive polymer film before and after application of a voltage for use with the systems and methods of the present disclosure.

FIG. 2 is a diagram of a fluid flow device according to one embodiment of the present disclosure.

FIGS. 3a-3f is a series of diagrams illustrating the movement of fluid through a fluid flow device according to the embodiment of the present disclosure shown in FIG. 1.

FIG. 4 is a diagram of a fluid flow device according to another embodiment of the present disclosure.

FIG. 5 is an example process for pumping fluid through a fluid flow device in accordance with aspects of the present disclosure.

FIG. 6 is an example process for sensing fluid pressure and/or fluid rate in a fluid flow device in accordance with aspects of the present disclosure.

FIG. 7a is an exploded view of a fluid flow device according to one embodiment of the present disclosure.

FIG. 7b is top view of an assembled fluid flow device according to the embodiment shown in FIG. 4.

FIG. 7c is a cross-sectional view of an assembled fluid flow device according to the embodiment shown in FIG. 4 taken along section line A-A shown in FIG. 7b.

FIG. 7d is an exploded view of a cross-section of the fluid flow device shown in FIG. 4.

FIG. 8a is a cross-sectional view of a fluid flow device in an off-state according to another embodiment of the present disclosure.

FIG. 8b is a cross-sectional perspective view of the fluid flow device according to the embodiment shown in FIG. 8a in an on-state.

FIG. 8c is a cross-section of a non-linear dome spring as used in a fluid flow device according to the embodiment shown in FIG. 8a.

FIG. 8d is an example diagram illustrating the use of a non-linear dome spring to cancel a spring rate of an actuator as used in a fluid flow device according to the embodiment shown in FIG. 8a.

FIG. 8e is an example diagram illustrating the force profile of a device that combines a non-linear dome spring and a spring rate of an actuator as used in a fluid flow device according to an embodiment of the present disclosure.

FIG. 9 is a cross-sectional view of a fluid flow device according to another embodiment of the present disclosure.

FIG. 10 is a cross-sectional view of a fluid flow device according to another embodiment of the present disclosure.

### DETAILED DESCRIPTION

Various embodiments are described to provide an overall understanding of the structure, function, manufacture, and use of the systems, devices, and methods disclosed herein. One or more examples of these embodiments are illustrated in the accompanying drawings. Those of ordinary skill in the art will understand that the devices and methods specifically described herein and illustrated in the accompanying drawings are non-limiting embodiments and that the scope of the various embodiments is defined solely by the claims. The features illustrated or described in connection with one embodiment may be combined, in whole or in part, with the features of other embodiments. Such modifications and variations are intended to be included within the scope of the claims.

With regard to the present disclosure, an electroactive polymer (“EAP”) material or film has two primary characteristics utilized within this disclosure. First, when an electrical charge (e.g., voltage or current) is applied and removed to the EAP, it will expand and contract according to the electrical charge deposited onto the electrodes of the EAP transducer. Second, the EAP will also change electrical characteristics (e.g., capacitance, resistance) independent of the applied actuation as it is stretched or compressed.

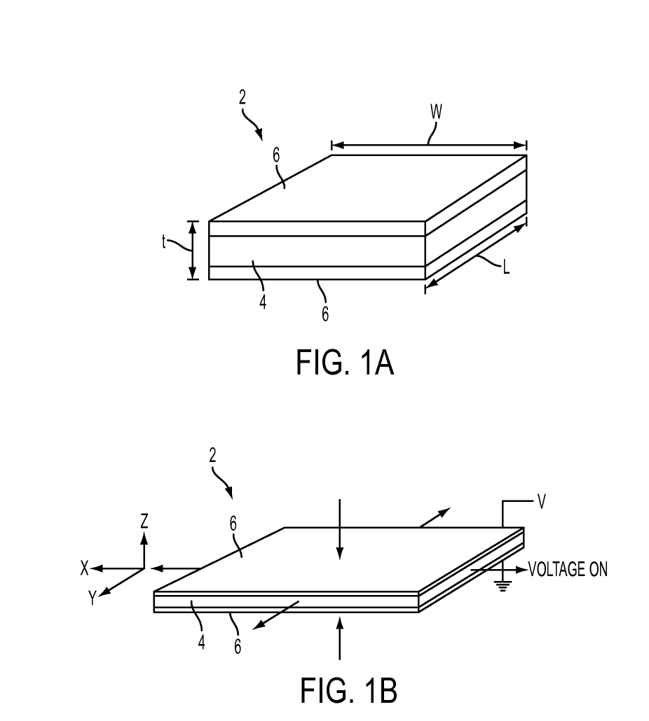

As illustrated in the schematic drawings of FIGS. 1a and 1b, an electroactive polymer (“EAP”) film 2 comprises a composite of materials which includes a thin polymeric dielectric layer 4 sandwiched between compliant electrode plates or layers 6, thereby forming a capacitive structure or device (which may be referred to, for example, as an actuator member, an actuator element, EAP transducer, or EAP actuator). As seen in FIG. 1b, when a voltage is applied across the electrodes, the unlike charges in the two electrodes 6 are attracted to each other and these electrostatic attractive forces compress the dielectric layer 4 (along the Z-axis). Additionally, the repulsive forces between like charges in each electrode tend to stretch the dielectric in plane (along the X- and Y-axes), thereby reducing the thickness of the film. The dielectric layer 4 is thereby caused to deflect with a change in electric field. According to embodiments in which the electrodes 6 are compliant, they change shape with dielectric layer 4. Generally speaking, deflection refers to any displacement, expansion, contraction, torsion, linear or area strain, or any other deformation of a portion of dielectric layer 4. Depending on the form fit architecture, e.g., the structure in which capacitive structure is employed, this deflection maybe used to produce mechanical work. Furthermore, an orientation of the EAP film 2 may be configured to obtain a force in a desired direction. The EAP film 2 may also be pre-strained within a frame or other structure to improve conversion between electrical and mechanical energy, i.e., the pre-strain allows the film to deflect more and provide greater mechanical work. In certain embodiments, the pre-strain improves the dielectric strength of the polymer, thereby offering improvement for conversion between electrical and mechanical energy by allowing higher field potentials.

With a voltage applied, the EAP film 2 continues to deflect until mechanical forces balance the electrostatic forces driving the deflection. The mechanical forces include elastic restoring forces of the dielectric layer 4, the compliance of the electrodes 6 and any external resistance provided by a device and/or load coupled to film 2. The resultant deflection of the film as a result of the applied voltage may also depend on a number of other factors such as the dielectric constant of the elastomeric material and its size and stiffness. Removal of the voltage difference and the induced charge causes the reverse effects, with a return to the inactive state as illustrated in FIG. 1a.

In certain embodiments, the length L and width W of EAP film 2 are much greater than its thickness; t. Typically the dielectric layer 4 has a thickness in range from about 1 μm to about 100 μm and is likely thicker than each of the electrodes. It is desirable to select the elastic modulus and thickness of electrodes 6 such that the additional stiffness they contribute to the actuator is generally less than the stiffness of the dielectric layer, which has a relatively low modulus of elasticity, i.e., less than about 100 MPa.

Classes of electroactive materials suitable for use with the fluid actuation systems and methods include but are not limited to dielectric elastomers, electrostrictive polymers, electronic electroactive polymers, piezoelectrics, and ionic electroactive polymers, and some copolymers. Suitable dielectric materials include but are not limited to silicone, acrylic, polyurethane, fluorosilicone, etc. Electrostrictive polymers are characterized by the non-linear reaction of electroactive polymers. Electronic electroactive polymers typically change shape or dimensions due to migration of electrons in response to electric field (usually dry). Ionic electroactive polymers are polymers that change shape or dimensions due to migration of ions in response to electric field (usually wet and contains electrolyte). Suitable electrode materials include carbon, gold, platinum, aluminum, etc. Suitable films and materials for use with the diaphragm cartridges of the present disclosure are disclosed in the following U.S. Pat. Nos. 6,376,971, 6,583,533, 6,664,718, which are herein incorporated by reference in their entirety.

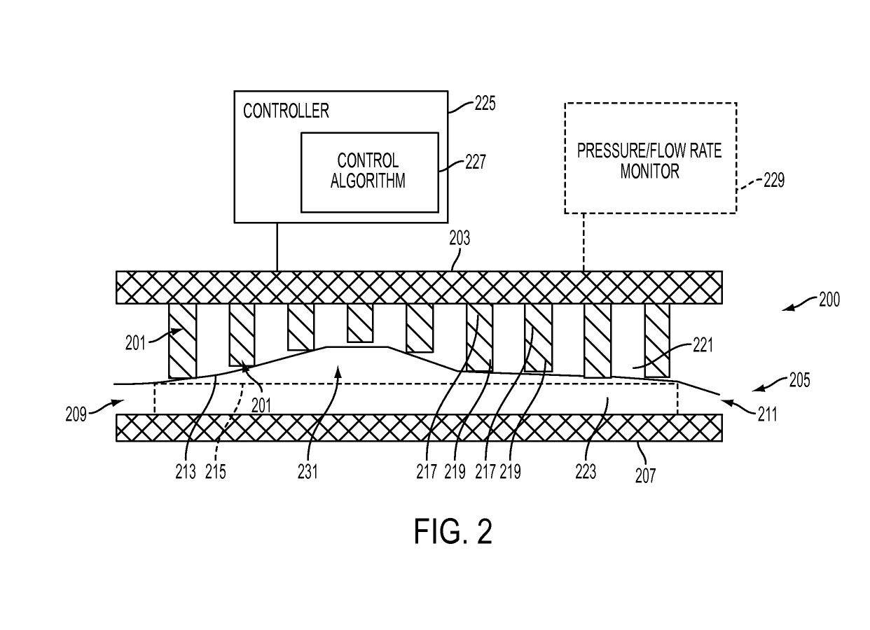

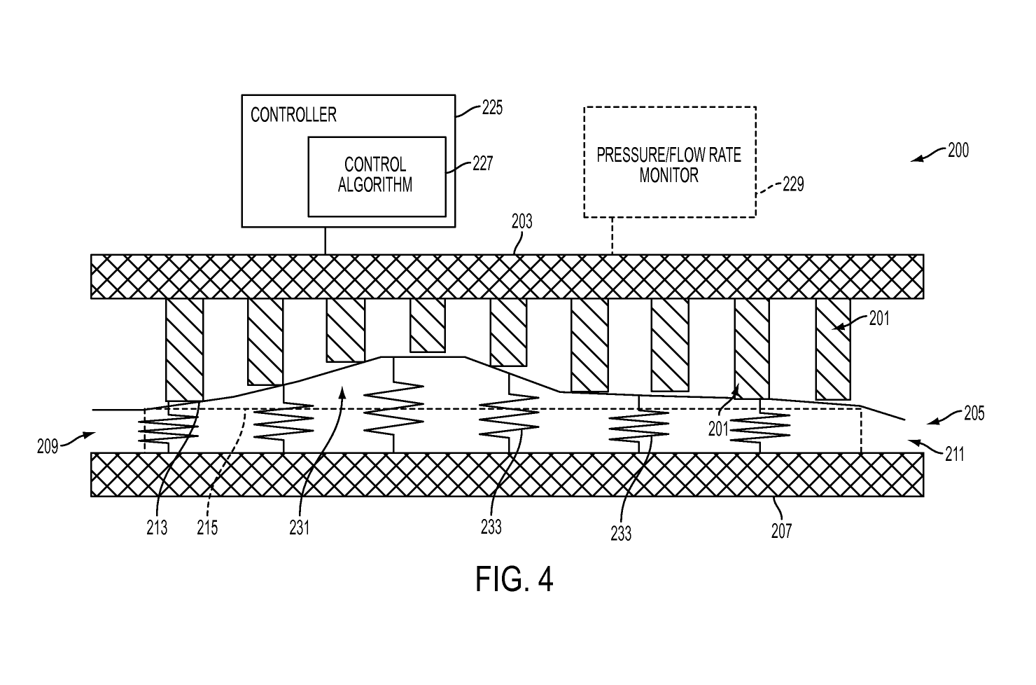

In FIGS. 2-11, various non-limiting embodiments of fluid flow devices and methods of use associated therewith are shown and described. As used herein the term fluid is applied in a general sense and includes, for example, gases, liquids, fluidized solids, slurries and other substances that have no fixed shape and yield easily to external pressure. As disclosed herein, a fluid flow device may be, for example, a valve assembly, apparatus, or device or a pump assembly, apparatus, or device that comprises a backing structure, a compression element, and at least one actuator element adjacent the compression element. The at least one actuator element is configured to compress the compression element towards the backing structure when the at least one actuator element is in a first state and the at least one actuator is configured to allow a fluid to flow from an inlet to an outlet of a fluid passage based on deflection of the at least one actuator element. The compression element may be a fluid passage member, a diaphragm, a spring element, or a component that carries or comes into contact with a fluid and stops, suppresses, or reduces fluid flow based on compression and/or decompression of the component. Further, the backing structure may be a housing and the fluid passage may be defined within the housing, and/or other components in addition to the housing.

In one embodiment, the at least one actuator element comprises an electroactive polymer (“EAP”) material that is configured to compress the compression element when the EAP material is in a first state, which may be an active or inactive state. The EAP material is configured to allow a fluid to flow from the inlet to the outlet of the housing based on deflection of the EAP material. Depending on the way the actuator is made/oriented, “active” or “inactive” may mean under an electric field or not under an electric field. In one embodiment, if the layers of an EAP actuator are in a stack or roll are normal to a fluid passage, the EAP actuator may be configured to compress the compression element under an electric field. In another embodiment, if the layers are parallel to the fluid passage, under field the EAP actuator may move away from the compression element.

With respect to FIGS. 2-4, a pump device 200 is disclosed that comprises a plurality of actuator members 201, an actuator backing structure 203, a fluid passage member 205, and a passage backing structure 207. The plurality of actuator members 201 are attached to the actuator backing structure 203 and the fluid passage member 205 is attached to the passage backing structure 207. The plurality of actuator members 201 are configured to contact an outer surface 221 of the fluid passage member 205 and compress the fluid passage member 205 against the passage backing structure 207 to allow a pressurized fluid to pass from an inlet 209 of the fluid passage member 205 to an outlet 211 of the fluid passage member 205. As shown in FIGS. 2-4, the fluid passage member 205 comprises a flexible membrane 213 and a delivery tube 215 where the flexible membrane 213 is located between the plurality of actuator members 201 and the delivery tube 215. In other embodiments, the fluid passage member is solely a conduit or tube that is suitable for fluid to pass from one end to another end.

In the embodiment shown in FIGS. 2-4, each of the plurality of actuator members 201 have a proximal end 217 and a distal end 219, where the proximal end 217 is closest to, or attached to the actuator backing structure 203 and the distal end 219 is farthest from the actuator backing structure 203. The plurality of actuator members 201 may configured to actuate in a first direction, which may include movement of the distal end 219 away from the actuator backing structure 203, such that the plurality of actuator members 201 are configured to compress the fluid passage member 205 against the passage backing structure 207 in that first direction. Accordingly, each of the actuator members 201 may have a first state, an off-state, where the actuator member 201 is uncharged and a distal end 219 of the actuator member 201 is located a first distance away from the passage backing structure 207. In a second state, an on-state, an electrical charge is applied to the actuator member 201 and as a result the distal end 219 of the actuator member 201 extends towards the passage backing structure 207 and away from the actuator backing structure 203 such that the distal end 219 of the actuator member 201 is located a second distance away from the passage backing structure 207. The first distance is further from the backing structure 207 than the second distance. In other embodiments, the states may essentially be reversed. Accordingly, in one embodiment, the first state may be the on-state, where the actuator member 201 is charged and a distal end 219 of the actuator member 201 is located a first distance away from the passage backing structure 207. In the second state, the off-state, the electrical charge applied to the actuator member 201 is removed and as a result the actuator member 201 extends towards the passage backing structure 207 and away from the actuator backing structure 203 such that the distal end 219 of the actuator member 201 is located a second distance away from the passage backing structure 207. In this example, the first distance being further from the backing structure 207 than the second distance.

As shown, the fluid passage member 205 has an outer surface 221, an inner surface 223, at least one inlet 209, and at least one outlet 211. The fluid passage member 205 may be any type of passage that is suitable for fluid to pass from one end to another end. For example, the fluid passage member may be defined by a channel in the backing structure 207 that has a covering that is flexible and/or resilient. Example types of fluids may be human fluids (e.g., blood, platelets, etc.) or fluids for use in residential or commercial environments (e.g., water, oil, gas, etc.). The fluid passage member 205 may have any desired size and shape that is appropriate for a particular application. In a preferred embodiment, the fluid passage member 205 is generally oblate in cross-section.

Additionally, the fluid passage member 205 may be sized and configured to flex and compress based on the action of the plurality of actuator members 201 and cause a fluid to progress from the inlet 209 to the outlet 211 of the fluid passage member 205. The fluid passage member 205 may be made in whole or in part from any desired type of material. In some embodiments, the selection of the material may be based on the application in which the fluid passage member 205 may be used. For example, for medical applications, the fluid passage member 205 may be made of medical grade materials. Preferably, the fluid passage member 205 is made from a resilient material. Example materials may include rubber, fluoropolymers (PFA, FEP, PVDF), engineering polymers, thermoplastic elastomers and polyolefins (LLDPE, HOPE, PP), etc. Accordingly, the fluid passage member 205 may be made from any material that has sufficient resilience to allow for deformation from compression by the plurality of actuator members 201 and subsequent reformation to an original, or close to original, form.

In a preferred embodiment, the plurality of actuator members 201 are electroactive polymer (“EAP”) actuator devices as described. The EAP actuator devices 201 may include a dielectric layer that separates a first electrode layer and a second electrode layer, also referred to herein as a pair of electrodes. When a voltage is applied to the electrode layers, the dielectric layer and the electrode layers form a capacitor that deforms or deflects. The thickness of the dielectric layer sandwiched between the electrode layers is reduced while the footprint of the electrode regions in increased.

The EAP transducer also varies in capacitance based on stress (e.g., stretching or compression of the EAP material) applied to the dielectric layer causing the EAP material to strain in accordance to the material stress/strain curve. The output capacitance and/or resistance may be correlated to strain applied to the material. For example, the dielectric layer is configured to change thickness and surface area based on an amount of force and/or pressure applied to the dielectric layer, which changes the output capacitance of the capacitor formed by the dielectric layer and the electrode layers. EAP transducers can also be used to monitor changes in temperature through changes in the output capacitance. In addition, the dielectric layer may be a dielectric elastomer.

Thus, in a first configuration, each of the EAP actuator devices 201 may be actuated by applying an electrical charge to the EAP actuator device 201. The electrical charge applied to the EAP actuator device 201 mounted to the actuator backing structure 203 functions to increase or decrease a volume of fluid contained within the inner surface of the fluid passage member 205 located between the distal end 219 of the EAP actuator device 201 and the passage backing structure 207. A series of the EAP actuator devices 201 electrically actuated in a prescribed manner can exert a compression force to the fluid passage member 205, which functions to move fluid through the fluid passage member 205 in a pumping action.

As shown in FIGS. 2-4, a series of EAP actuator devices 201 may be mounted along a portion or all of a backing structure 203 in a spaced apart format. The spacing of the EAP actuator devices 201 may be uniform or non-uniform depending on the intended application. The EAP actuator devices 201 may be attached to or mounted on the actuator backing structure 203 using any desirable mechanism. Suitable mounting mechanisms may include, for example, pressure sensitive adhesive, curable pressure sensitive adhesive, UV curable pressure sensitive adhesives, epoxies, cyanoacrylates, urethanes, acrylics, thermosetting adhesives, etc. In other embodiments, the EAP actuator devices 201 are attached to actuator backing structure 203 based on a threaded connection or a friction fit.

Similarly, the fluid passage member 205 may be held in place against, coupled to, or attached to the passage backing structure 207 in any desired manner, such as those listed above. Preferably, the fluid passage member 205 may be secured to passage backing structure 207 in order to isolate the fluid passage member 205 from arbitrary twisting and bending movements it might be subjected to during normal use. Further, the passage backing structure 207 may include a groove or channel in which at least a portion of the fluid passage member 205 is intended to fit.

A controller 225 may be coupled to each of the EAP actuator devices 201 such that the controller 225 is configured to selectively activate each of the plurality of actuator members 201 to force or allow fluid through a portion or the entirety of the fluid passage member 205. The controller 225 may be configured to activate the plurality of actuator members 201 sequentially along a length of the pump device 200, from the inlet 209 to the outlet 211 of the fluid passage member 205. The controller 225 by itself or in conjunction with the control algorithm 227 may be configured to actuate each of the EAP actuator devices 201 to generate a flow of fluid through fluid passage member 205, from the inlet 209 to the outlet 211. For example, in one embodiment, the fluid passage member 205 will be allowed to extend or expand outward (increase volume) from the passage backing structure 207 when an electrical charge is supplied to the EAP actuator devices 201, hence causing the EAP actuator devices 201 that are in contact with the fluid passage member 205 to contract. When the electrical charge is removed from the EAP actuator devices 201, the EAP actuator devices 201 may expand back to a reduced volume state with regard to the fluid passage member 205. The controller 225 may implement a control algorithm 227 that the controller 225 executes in order to obtain a desired flow rate of fluid through the fluid passage member 205 and/or control activation of the EAP actuator devices 201 to obtain any desired output through the fluid passage member 205.

In an additional configuration, the EAP actuator devices 201 will also change electrical characteristics (e.g., capacitance, resistance) independent of the applied actuation (e.g., electrical charge and capacitance, resistance) as they are stretched or compressed. Therefore, the electrical charge output by the EAP actuator devices 201 may be correlated to strain and/or fluid pressure contained within the fluid passage member 205. Such EAP actuator devices 201 may utilize an electrical output signal, for example, an analog output signal, for sensing a physical characteristic of the fluid passage member 205 by changing an electrical property (e.g., capacitance and/or resistance) of the EAP actuator device 205, which may be monitored or otherwise recorded.

Accordingly, an electrical charge output by the EAP actuator devices 201 may correlate to a strain and/or fluid pressure contained within a fluid passage member 205. For example, the fluid passage member 205 will expand outward as fluid is moved from the inlet 209 to the outlet 211, hence causing the EAP actuator devices 201 that are adjacent or in contact with the fluid passage member 205 to be compressed according to how close the EAP actuator devices 201 are to the fluid passage member 205. As the fluid passage member 205 expands with pressure, the electrical output signal of each of the EAP actuator devices 201 will also vary and can be monitored and/or processed to determine status of the fluid passage member 201 and/or rate of fluid passing through the fluid passage member 205, for example. This produces an effective method for measuring internal fluid pressure within a fluid passage member 205 non-invasively.

The controller 225 may also be coupled to each of the EAP actuator devices 201 to monitor capacitance and/or resistance of the EAP actuator device 201 in order to sense fluid pressure and/or fluid flow rate through the fluid passage member 205. This sensing function can be implemented when the EAP actuator device 201 has an electrical signal supplied or not. If an electrical signal is applied and held for a prescribed amount of time, the EAP actuator device 201 may be used to sense fluid pressure and/or fluid flow rate during a prescribed amount of time. This is possible due to the change electrical characteristics associated with having the EAP actuator device 201 in a fixed position (assuming a substantially constant electrical charge is applied to the EAP actuator device 201).

Alternatively, as shown in FIG. 1, the pump device 200 may include a pressure monitor device 229 coupled to the actuator members to receive readings regarding capacitance and/or resistance of the EAP actuator devices 201. The EAP actuator devices 201 may be operable to provide a physical characteristic associated with the fluid passage member 205 to the pressure monitor device 229. In another embodiment, at least one pressure sensor (not shown) may be mounted between the outer surface 221 of the fluid passage member 205 and the distal end 219 of at least one of the EAP actuator devices 201 to provide feedback to the controller 225 or pressure monitor device 229. In the event that multiple sensors are used, the sensors may be spaced apart a prescribed distance, which can be uniform or non-uniform.

The controller 225 may take a variety of forms including a circuit, such as, for example, a combinational logic circuit or a sequential logic circuit (either synchronous or asynchronous), a finite state machine, a computer, tablet, processor, microprocessor, ASIC, etc. In one embodiment, the controller 225 may be configured to determine and control a flow rate or pressure of fluid through the fluid passage and to determine whether a predefined threshold level is met or exceeded. In another embodiment, the controller 225 may be configured to execute operating logic in a storage medium and the operating logic may be directed to functions as described. In another embodiment, the controller 225 may comprise a non-transitory computer readable medium such that data regarding a flow rate of fluid through the fluid passage or fluid pressure in is stored in the non-transitory computer readable medium. Furthermore, the functions described regarding the controller 225 and other appropriate components may be performed by hardware or software.

Further, the controller 225 may include functionality to provide data regarding flow rate of fluid through a fluid passage and/or a fluid pressure in the fluid passage to a communications network, such as a public or private communication network, using wired or wireless channels, and can be any network or combination of networks that can carry data communications. Furthermore, as multiple devices are used multiple controllers may be able to provide to provide data regarding flow rate of fluid through a fluid passage and/or a fluid pressure in the fluid passage to a communications network. The data may collected and used for further analysis as desired.

As discussed, the EAP actuator devices 201 are configured to be electrically actuated in a prescribed manner to exert a squeezing or compression force to the fluid passage, which functions to pump fluid through the fluid passage. As shown in FIGS. 2a-2f, the EAP actuator devices 201 can be configured to compress the fluid passage member 205 against the passage backing structure 207 according to a wave-shape configuration. This configuration can be translated along the fluid passage by sequentially addressing groups of actuator members. In the embodiment shown in FIGS. 2a-2f, a volume 231 in a portion of the fluid passage member 205 that is located between the EAP actuator devices 201 and passage backing structure 207 is decreased as a distal end 219 of the EAP actuator device 201 moves away from the actuator backing structure and towards the passage backing structure 207 and the volume 231 in a portion of the fluid passage member 205 that is located between the EAP actuator devices 201 and passage backing structure 207 is increased as a distal end 219 of the EAP actuator device 201 moves away from the passage backing structure 207. The movement of the distal ends 219 of each of the EAP actuator devices 201 corresponds to an amount of charge placed on each of the EAP actuator devices 201. In another embodiment, a volume of a portion of the fluid passage member 205 that is located between the EAP actuator device 201 and passage backing structure 207 is increased as a distal end 219 of the EAP actuator device 201 contracts away from the passage backing structure 207 and moves towards the actuator backing structure 203. In this embodiment, the movement of the distal end 219 of each of the EAP actuator devices 201 corresponds to a charge being placed on each of the EAP actuator devices 201.

Accordingly, the plurality of EAP actuator devices 201 can be configured to move a fluid from the inlet 209 to the outlet 211 according to a wave-shape configuration. In the embodiment shown in FIGS. 2a-2f, the fluid is moved in a linear or straight-line direction from the inlet 209 to the outlet 211 of the fluid passage member 205. In other embodiments, a pump device may include a plurality of actuator members, the actuator backing structure, the fluid passage, and the passage backing structure configured such that fluid is moved in direction other than linear from the inlet to the outlet of the fluid passage member. For example, there may be a 180 degree bend between the inlet and the outlet of the fluid passage member. Similarly, a 90 degree angle may present, along with other angles depending the particular desired application.

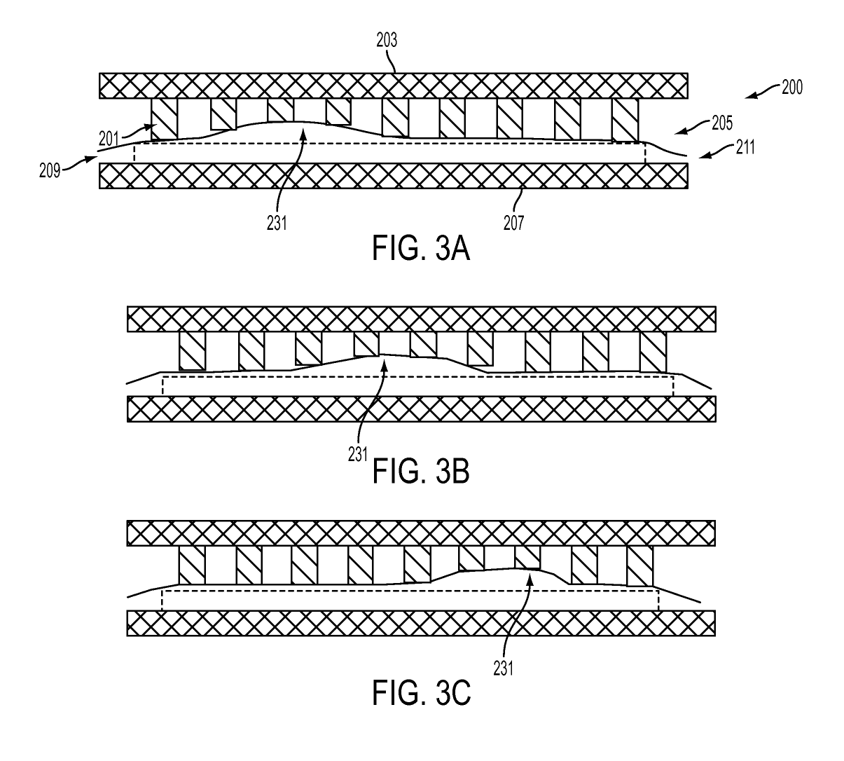

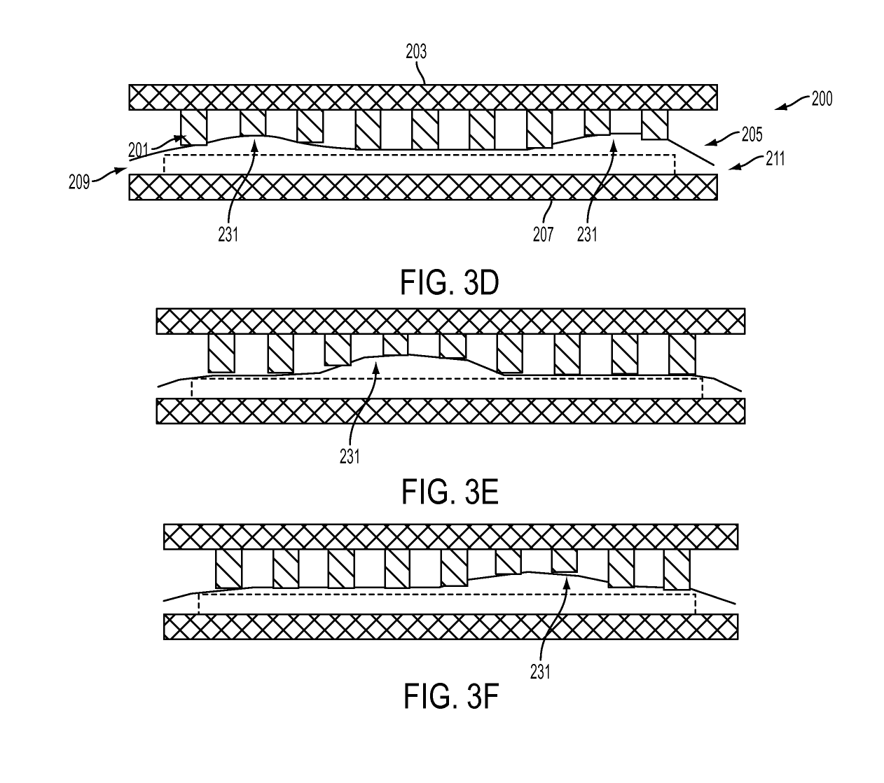

Furthermore, at least one spring member 233 may be placed along a fluid passage member 205 to increase the resiliency of the fluid passage member 205. As shown in FIG. 3, at least one spring member 233 may be coupled to the flexible membrane 213 in order to provide a force that acts against the plurality of actuator members 201. Spring members 233 may placed at uniform intervals, such as for example, corresponding to the actuator members 201, or at non-uniform intervals. The spring member 233 may be any form of device or apparatus that provides a resilient effect when it is compressed. Such device or apparatus may include, for example, metallic springs, rubber and/or plastic formations, and EAP devices. In another embodiment, the at least one spring member 233 is located along the inner surface 223 of the fluid passage member 205.

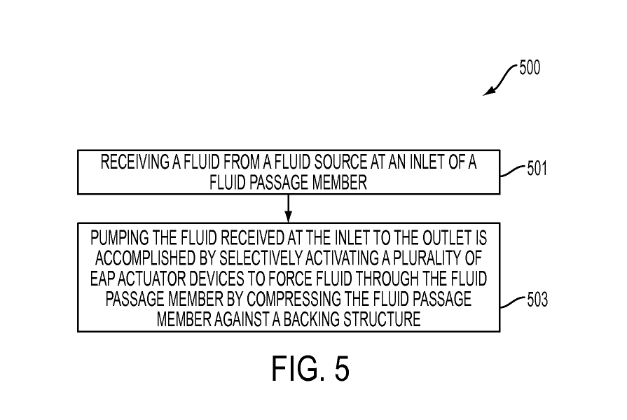

FIG. 5 is an example process 500 for pumping fluid through a fluid passage as described herein. At block 501, the method 500 comprises receiving a fluid from a fluid source at an inlet of a fluid passage member, where the fluid passage member has an outer surface and an outlet in fluid communication with the inlet, and the fluid passage member is coupled to a passage member backing structure. At block 503, pumping the fluid received at the inlet to the outlet is accomplished by selectively activating a plurality of EAP actuator devices to force fluid to flow through the fluid passage member by compressing the fluid passage member against a backing structure. Each of the plurality of the EAP actuator devices may be actuated in a desired manner. In one embodiment, the EAP actuator devices are sequentially actuated in a predefined manner to force fluid through the fluid passage member. In another embodiment, each of the plurality of EAP actuator devices is operated in a coordinated manner (singularly, in groupings, or in any desired manner) to obtain a desired flow rate of fluid through the fluid passage member.

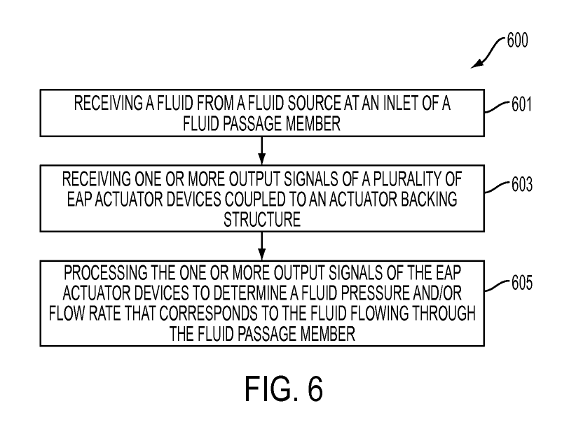

FIG. 6 is an example process 600 for sensing fluid pressure and/or fluid rate in a fluid passage member. At block 601, the method includes receiving fluid from a fluid source at an inlet of a fluid passage member. The fluid passage member has an outer surface and an outlet in fluid communication with the inlet, and the fluid passage member is coupled to a backing structure. As discussed above, each of the plurality of EAP actuator devices have a first state with no electrical charge supplied to the EAP actuator device and a second state when an electrical charge is applied to the EAP actuator device. In one embodiment, the second state corresponds to a decreased volume of the fluid passage member caused by expansion of the EAP actuator device adjacent an outer surface of the fluid passage member. In another embodiment, the second state corresponds to an increased volume of the fluid passage member caused by contraction of the EAP actuator device adjacent an outer surface of the fluid passage member.

At block 603, the method includes receiving one or more output signals from a plurality of EAP actuator devices coupled to an actuator backing structure. Each of the EAP actuator devices output an output signal based on an amount of fluid pressure and/or fluid flow rate detected in the fluid passage member at a location in which an EAP actuator device is adjacent to the fluid passage member. In each of the first state (no electrical charge applied to the EAP actuator device) and second state (an electrical charge applied to the EAP actuator device), each of the plurality of EAP actuator devices is configured to measure fluid pressure and/or fluid flow rate through the fluid passage member. At block 605, the method 600 includes processing the one or more output signals of the EAP actuator devices to determine a fluid pressure and/or flow rate that corresponds to the fluid flowing through the fluid passage member.

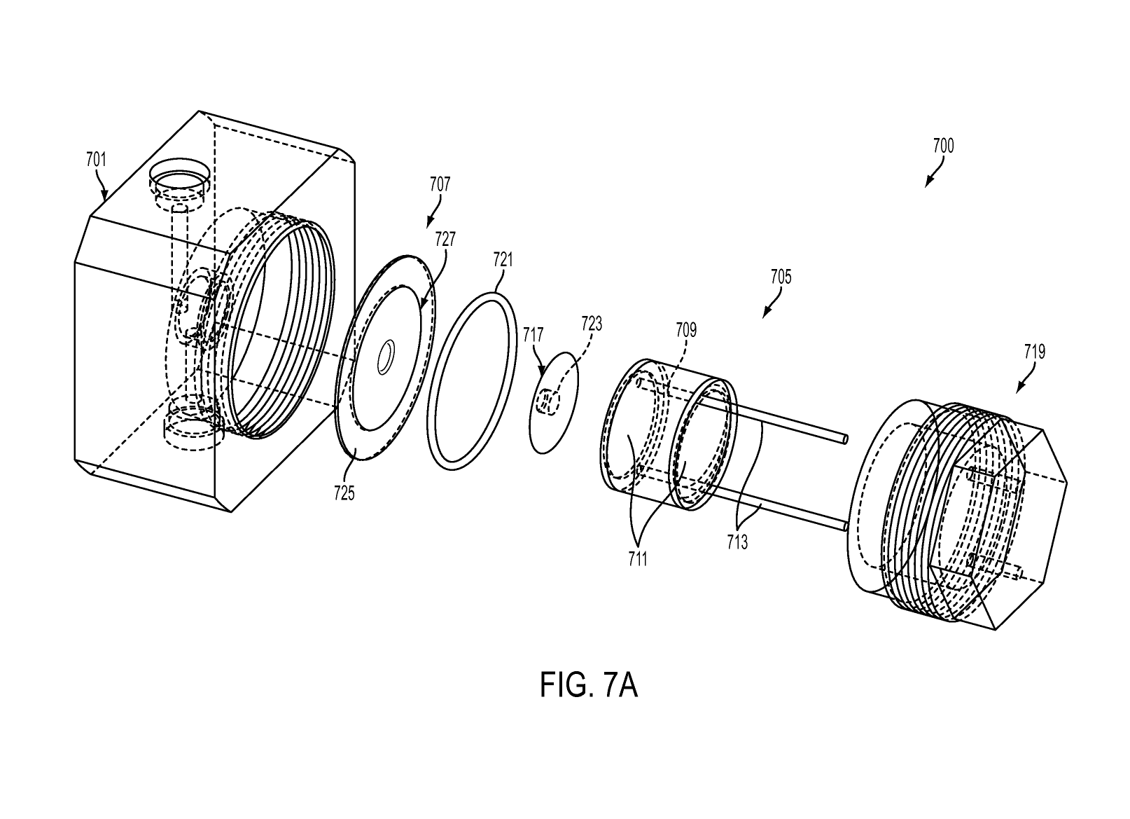

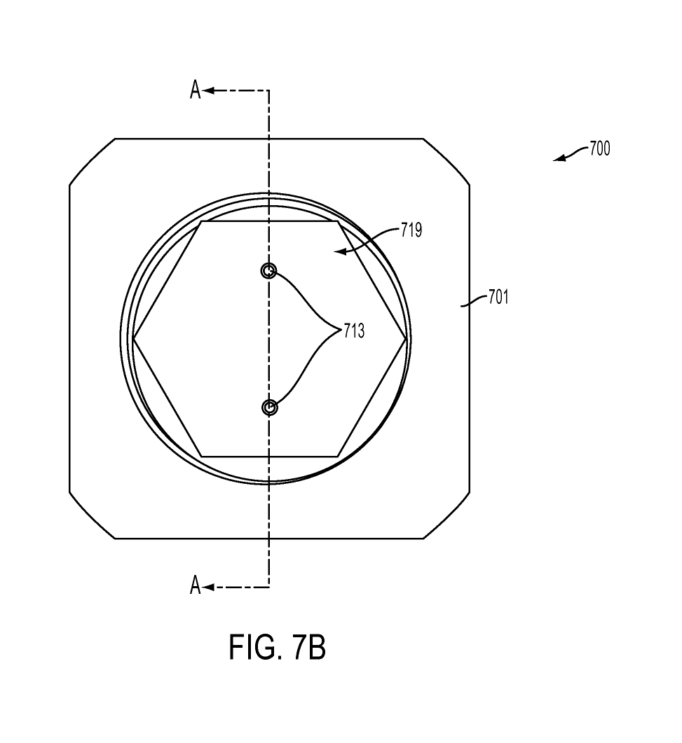

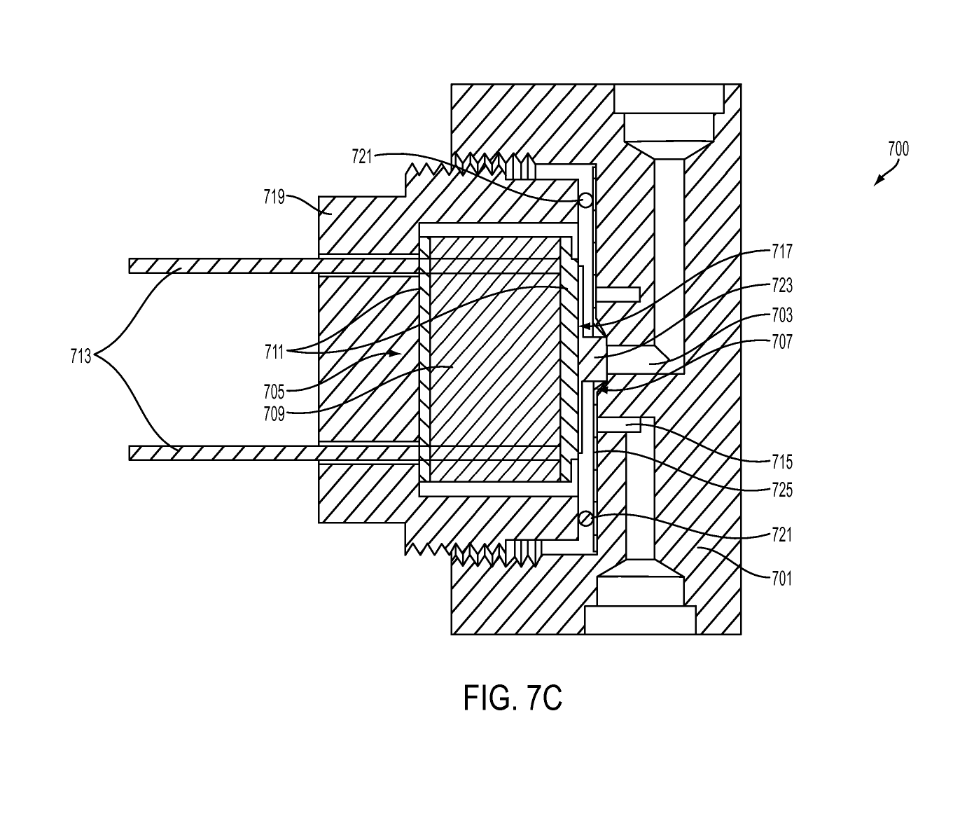

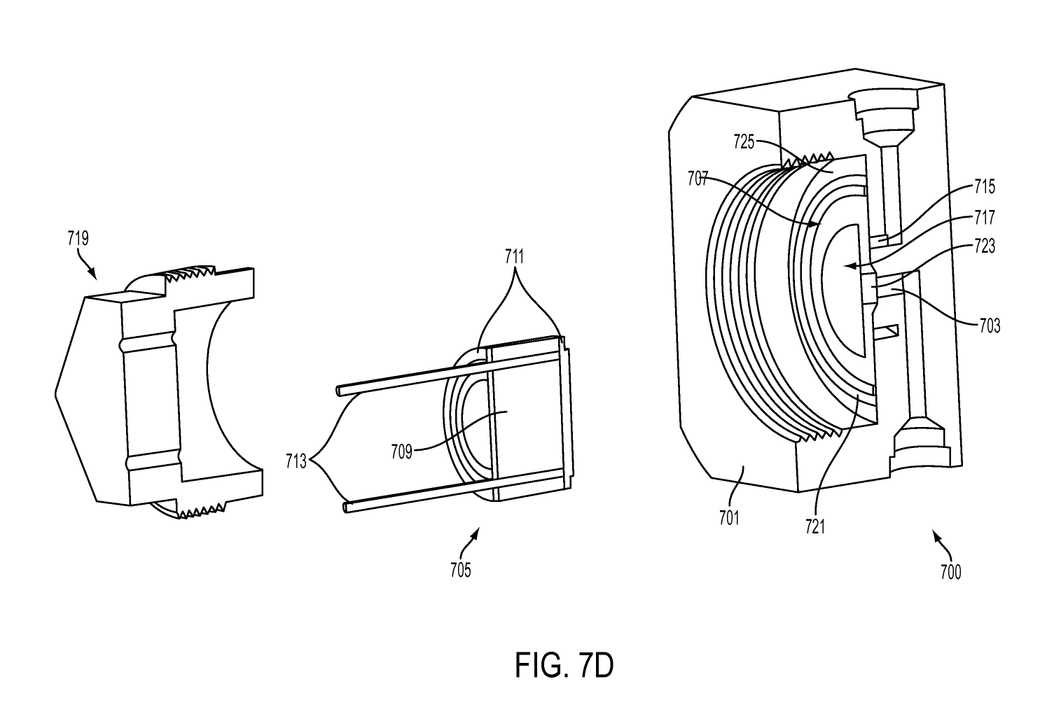

As shown in FIGS. 7a-7d, an actuation valve 700 comprises a housing 701 having at least one aperture 703, an actuator element 705, and a diaphragm 707. The diaphragm 707 is located between the actuator element 705 and at least one aperture 703 of the housing 701. The actuator element 705 comprises an electroactive polymer (“EAP”) 709, a set of electrodes 711, and a set of current leads 713. The set of electrodes 711 are configured to provide an electrical charge to the EAP 709 that is received from the current leads 713. The set of current leads 713 receive the electric charge from a power source (not shown). The actuator element 705 is configured to compress the diaphragm 707 adjacent the at least one aperture 703 of the housing when the EAP 709 is in a first state.

In the embodiment shown in FIGS. 7a-7d, the at least one aperture 703 is an inlet of the housing 70l and the actuator element 705 acts as a valve that is designed to compress the diaphragm 707 against the inlet 703 of the housing 707 to prevent fluid from flowing through the inlet 703. The housing 701 is also shown as having an outlet 715. A fluid passage is defined by the inlet 703, the outlet 715, and the space created by the diaphragm 707 when the diaphragm is not compressed against the inlet 703 (or the outlet 715 in other embodiments). Upon activation of the EAP 709, the actuator element 705 is configured to allow fluid to flow through the inlet 703 to the outlet 715 through the fluid passage by movement of the diaphragm 707 away from the inlet 703. As such, the actuation valve 700 allows a pressurized fluid to flow from the inlet 703 to the outlet 715. In another embodiment, the diaphragm 707 may be configured to be compressed against the outlet 715 of the housing 707 or against both the outlet 715 and the inlet 703 simultaneously. In another embodiment, the at least one aperture 703 is a single aperture and fluid passes into and out of the single aperture.

The actuator element 705 has similar characteristics with regard to the EAP actuator(s) discussed above. The first state of the actuator element 705 may correspond to an off-state, where the EAP 709 of the actuator element 705 is uncharged. In a second state, an on-state, an electrical charge is applied to the EAP 709. Accordingly, in the first state, the EAP 709 of the actuator element 705 may cause the actuator element 705 to exert a compressive force against the diaphragm 707, such that the diaphragm 707 seals the inlet 703 and outlet 715 of the housing 707. When an electrical charge is applied to the EAP 709, in the second state or on-state of the actuator element 705, the EAP 709 may expand and the actuator element 705 may allow the diaphragm 707 to move away from the inlet 703.

In other embodiments, the states may essentially be reversed. Accordingly, in one embodiment, the first state may be the on-state, where the EAP 709 is charged and in the second state, the off-state, no electrical charge is applied to the EAP 709. Furthermore, depending on the design and configuration of the actuator element 705, the EAP 709 may cause a compressive force to be exerted on the diaphragm 707 when the EAP 709 is charged or uncharged, i.e. an electrical charge may cause an expansion or contraction of the EAP 709 depending on the configuration of the EAP 709 within the actuator element 705. In addition, in one embodiment, the diaphragm 707 is pre-compressed based on a force exerted by the actuator element 705. In another embodiment, the diaphragm 707 is not pre-compressed based on the actuator element 705.

As the actuator element 705 applies a force to the diaphragm 707 to prevent fluid flow through the inlet 703 of the housing 701, the force applied may correspond to a desired pressure at the inlet 703 of the housing 701. Accordingly, the actuation valve 700 may be a pressure valve that is rated to handle or apply a desired amount of fluid pressure based on the force applied by the actuator element 705. The amount of force applied by the actuator element 705 depends on parameters such as, for example, the size and configuration of the EAP 709 itself, an amount of charge of the EAP 709, and whether the EAP 709 is pre-strained.

According to the embodiment in FIGS. 7a-7d, the actuation valve 700 further comprises a focused compression component 717, a preloading element 719, and an annular element 721. The focused compression component 717 may be located between the diaphragm 707 and the actuator element 705 and is configured to transfer a focused compressive force to the diaphragm 707 according to a force exerted by the actuator element 705. As shown in FIGS. 7a-7d, the focused compression component 717 has a circular shape, but the focused compression component 717 may be sized and configured according to the application of the actuation valve 700 and may take on any shape as appropriate. The focused compression component 717 may also have at least one extension 723, such as a ridge, where the ridge 723 is configured compress the diaphragm 707 against the inlet 703 of the housing 701. In other embodiments, the ridge 723 may be configured to compress the diaphragm 707 against the outlet 715 of the housing 701 or both the inlet 703 and the outlet 715 of the housing. Similar to the focused compression component 717, the extension 723 may be sized and configured according to the application of the actuation valve 700 and may take on any shape as appropriate.

Also as shown in FIGS. 7a-7d, the preloading element 719 is a compression cap that is sized and configured to attach to the housing 701 based on a threaded engagement. The compression cap 719 has a threaded configuration and the housing 701 has a corresponding threaded configuration to receive the compression cap 719. In other embodiments, the preloading element 719 may take on other shapes and/or other means of engagement or attachment to the housing 701. For instance, the preloading element 719 may be engaged with the housing 701 based on a friction fit. The preloading element 719 may also be held into an engagement within the housing 701 strap, clamp, or other attachment means such that the distance between the preloading element 719 and the housing 701 be adjustable based on the attachment means.

Based on the configuration of the preloading element 719, a force exerted by the actuator element 705 to compress the diaphragm 707 against the at least one aperture 703 of the housing 701 may be adjustable according to the engagement of the preloading element 719. The force exerted by the actuator 705 on the diaphragm 707 corresponds to the state of the EAP 709. By adjusting the distance between the preloading element 719 and the housing 701, which may also adjust a distance between the actuator element 705 and the diaphragm 707 or at least an initial force to be applied to the diaphragm 707 by the actuator element 705 (which may be zero), the force exerted by the actuator element 705 to compress the diaphragm 707 against the at least one aperture 703 of the housing 701 may be increased or decreased. For example, in the embodiment shown in FIGS. 7a-7d, the threaded configuration of the compression cap 719 allows the compression cap 719 to be moved into or out of engagement with the housing 701. Accordingly, if the compression cap 719 is threaded into the housing 701 at a first distance; a first amount of force is applied to the diaphragm 707 by the actuator element 705 upon activation or deactivation of the actuator element 705. If the compression cap 719 is threaded into the housing 701 at a second distance, where the second distance is smaller than the first distance, a second amount of force that is to be applied to the diaphragm 707 by the actuator element 705, upon activation or deactivation of the actuator element 705, is greater than the first amount of force.

Further, the annular element 721 is configured to act as a washer to hold an outer edge 725 of the diaphragm 707 in place against the housing 701 when the preloading element 719 is in located within the housing 701. As shown in the embodiment of FIGS. 7a, 7b, and 7d, the annular element 721 may be located between the preloading element 719 and the diaphragm 707, and adjacent the actuator element 705 but not between the actuator element 705 and the diaphragm 707. The diaphragm 707 may include a raised section 727 that coordinates with the annular element 721 to provide a guide for fitting the annular element 721. Further, the annular element 721 may be formed as part of the preloading element 719 or may be a separate component, as shown in FIGS. 7a-7d. Additionally, while the actuation valve 700 is shown configured as a valve in FIGS. 7a-7d, the addition of other elements, such as check valves, may allow for implementation of a pump configuration. Accordingly, in one embodiment, an inlet valve element is located at the inlet 703 of the housing 701 and an outlet valve element is located at the outlet 715 of the housing 715. In another embodiment, a check valve may be added downstream of inlet 703 and/or outlet 715 of the housing 701.

Activation of the actuator element 705 is accomplished via a charge applied to the sets of electrodes 711 of the actuator element 705. A controller (not shown) may also be coupled to the actuator element 705 via the set of current leads 713, such that the controller is configured to selectively activate the EAP 709 of the actuator element 705 to allow a fluid to pass through the at least one aperture 703 of the housing 701. The controller is similar to controller 225 described above and may include any or all aspects of controller 225 as described. Further, the controller may include the pressure and flow rate monitoring functions described above or a separate pressure or flow rate monitoring device may be employed, as described above.

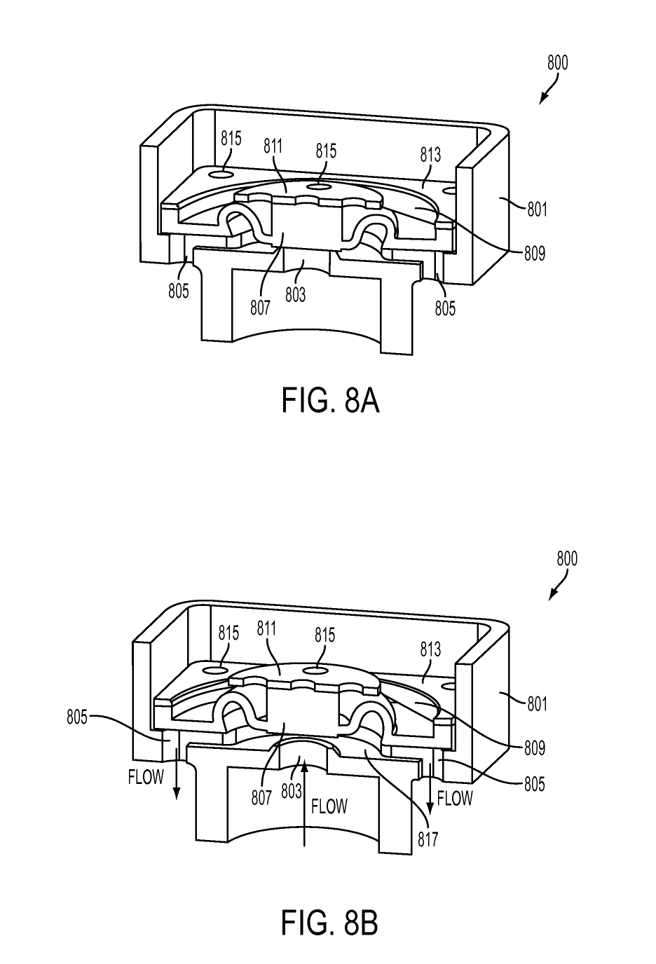

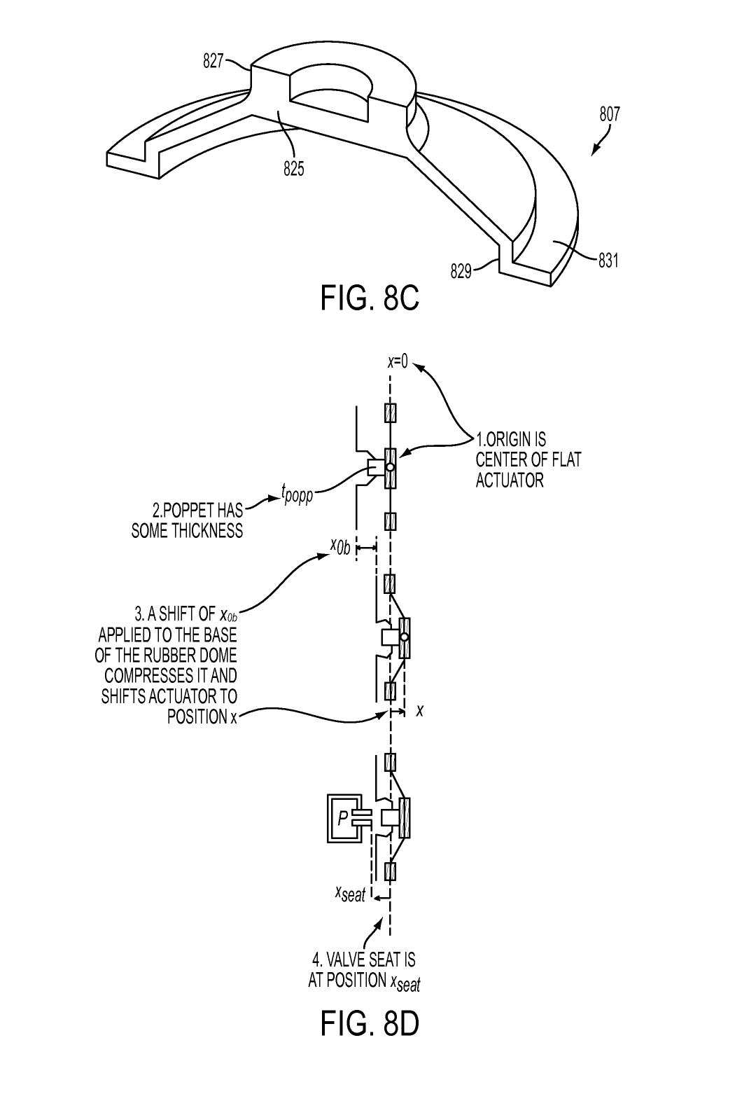

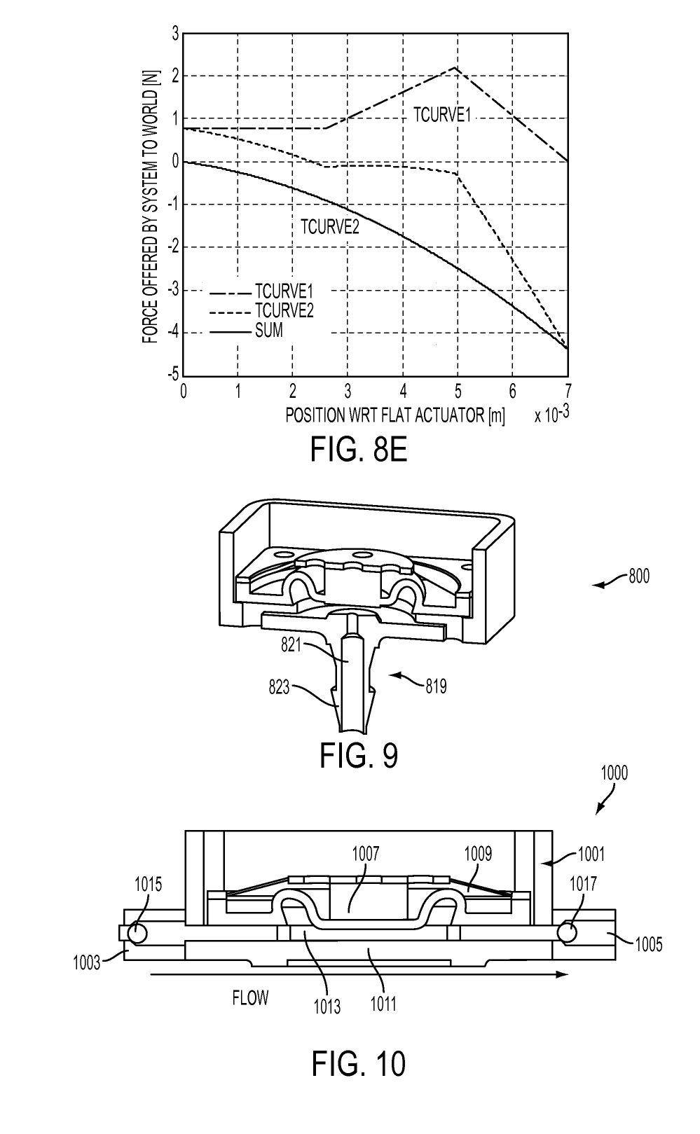

Another embodiment of a fluid flow device is shown in FIGS. 8a and 8b. As shown in FIGS. 8a and 8b, a spring valve 800 comprises a housing 801 having an inlet 803 and at least one outlet 805, a diaphragm 807 adjacent the inlet 803 and the outlet 805 of the housing 801, and an electroactive polymer (“EAP”) material 809 coupled to the housing 801. The EAP material 809 is configured to have an on-state, where the EAP material 809 is energized, and an off-state, where the EAP material 809 is not energized. The EAP material 809 is configured to compress the diaphragm 807 against the inlet 803 or the outlet 805 of the housing 801 when the EAP material 809 is in the off-state and to avoid compression of the diaphragm 807 against the inlet 803 or the outlet 805 of the housing 801 when the EAP material 809 is in the on-state. In another embodiment, the EAP material 809 may be configured to compress the diaphragm 807 against the inlet 803 or the outlet 805 of the housing 801 when the EAP material 809 is in the on-state and to avoid compression of the diaphragm 807 against the inlet 803 or the outlet 805 of the housing when the EAP material 809 is in the on-state. The diaphragm 807 is configured to at least partially cancel a stiffness of the EAP material 809 with a negative spring rate mechanism. According to the embodiment shown in FIGS. 8a and 8b, the diaphragm 807 comprises a non-linear dome spring (“NDS”). A preferred embodiment of a NDS 807 is shown in FIG. 8c where the NDS 807 has a poppet 825, boss 827, base 829, and valve seat 827. In another embodiment, the diaphragm 807 comprises a linear dome spring. In other embodiments, the diaphragm 807 may comprise beams or other appropriately shaped and sized configurations. Furthermore, the material of the diaphragm 807 may be any appropriate elastic and resilient material, such as silicone polymer, at an appropriate thickness with an appropriate cross-sectional profile to accomplish the desired resilient effect.

FIG. 8d illustrates an example of how an NDS is used to cancel a spring rate of an EAP actuator, so that the device can move farther. Initially, relative coordinates are defined as shown in FIG. 8d. Ignoring the valve seat of the NDS, the NDS compressed against the EAP actuator is analyzed. An NDS made of a polymer with modulus 4.6 MPa is made according to a geometry illustrated in FIG. 8c. The following dimensions are applicable: the NDS has a wall thickness of about 0.45 to 0.53 mm, a diameter at the base measures 13.7 mm, an 8 mm diameter boss at the top, and the underside of the boss measures It is 3.1 mm. Of this distance, about 0.6 mm is vertical wall. The NDS is pushed into 7 mm of interference with a dielectric elastomer actuator. A piece-wise linear approximation of the NDS force-displacement curve (Tcurve1) and its interaction with an EAP actuator (Tcurve2) is illustrated in FIG. 8e.

By itself, the EAP actuator has a non-linear force-displacement relation (Tcurve2). The combination of the NDS and EAP force-displacement curves yields the force-displacement curve for the system (Sum). Coupled together, the system comes to rest at 2.3 mm, where the sum of Forces is zero. Because the NDS has canceled much of the spring rate of the cartridge, only a little force (<0.1 N) is now required to move the system a long distance (e.g. to 5 mm) In a valve application, as used in the present disclosure, the poppet is able move an effective distance off the valve seat.

Further, as shown in FIGS. 8a and 8b, the inlet 803 is a center port, and the dome spring 807 is configured to compress against the center port 803 when the EAP material 809 is in the off state. FIG. 8a illustrates the spring valve 800 in a closed configuration and FIG. 8b illustrates the spring valve 800 in an open configuration. The arrows shown in FIG. 8b indicate the flow path of a fluid that moves through the fluid passage 817 of the housing 801 when spring valve 800 is open. Also shown are a center plate 811 and a surrounding plate 813 that couple the EAP material 809 to the diaphragm 807 and the housing 801, respectively. In the embodiment shown in FIGS. 8a and 8b, the center plate 811 and the surrounding plate 813 act as electrodes to provide an activation of the EAP material 809. In one embodiment, the center plate 811 is first electrode and the surrounding plate 813 is second electrode for energizing the EAP material 809. In another embodiment, the center plate 811 may comprise one or more electrodes and/or the surrounding plate 813 may comprise one or more electrodes for energizing the EAP material 809. As shown in FIGS. 8a and 8b, the center plate 811 and surrounding plate 813 include apertures 815 for control leads (not shown) that are designed to be coupled to a power source (not shown). In other embodiments, electronics, which may include control devices, are configured to be placed in the top of the housing 801 and the housing 801 may be closed with a cover (not shown). Mounting features (e.g., tabs with holes) can be added to the sides of the housing 801.

Activation of the EAP material 809 is accomplished via a charge applied to control leads and/or the electrodes that contact the EAP material 809. A controller (not shown) may also be coupled to the EAP material 809, such that the controller is configured to selectively activate the EAP material to allow a fluid to pass through the inlet 803 to the outlet 805 of the housing 801. The controller is similar to controller 225 described above and may include any or all aspects of controller 225 as described. Further, the controller may include the pressure and flow rate monitoring functions described above or a separate pressure or flow rate monitoring device may be employed, as described above.

The center plate 811 is configured to contact a top surface of the diaphragm 807 and, as the EAP material 809 deflects, the center plate 811 moves towards or away from the center port 803. In another embodiment, the center plate 811 may comprise two caps that sandwich a section of EAP material 809 in between. Accordingly, the EAP material 809 may be a planar sheet or may be a ring-shaped section of material. Further, the surrounding plate 813 couples the EAP material 809 to the housing by sandwiching the EAP material 809 in between the surrounding plate 813 and the component that is located below the EAP material 809. As shown in FIGS. 8a and 8b, the surrounding plate 813 holds the EAP material 809 against an outer edge 817 of the diaphragm 807. In other embodiments, the surrounding plate 813 may hold the EAP material 809 against an edge that is part of the housing 801 or a separate components such as a washer.

As shown in FIG. 9, the housing 801 may include a stem 819 extending away from the center port 803. A passage 821 through the stem 819 may decrease in volume along a length of the passage 821 such that a fluid flowing through the passage 821 reaches its highest pressure just before moving through the center port 803. The stem 819 may also have a distal end 823 with a shape, such as a barbed fitting, that is configured to engage a corresponding aperture in another component or device. The top of the housing 801 provides room for electronics and may be closed with a cover (not shown). Mounting features (e.g., tabs with holes) can be added to the sides of the housing 801. In one embodiment, the housing 801 integrates a barbed fitting, the inlet and outlet, and a valve seat for the diaphragm in one molded part.

Similar to the actuation valve 700 discussed above, while the spring valve 800 is shown configured as a valve in FIGS. 8a and 8b, the addition of other elements, such as check valves, may allow for implementation of a pump configuration. Accordingly, in one embodiment, an inlet valve element located at the inlet of the housing and an outlet valve element located at the outlet of the housing, may be provided. In another embodiment, a check valve may be added downstream of inlet 803 and/or outlet 805 of the housing 801.

FIG. 10 shows a pump device 1000 similar to that described. The pump device 1000 comprises a housing 1001 having an inlet 1003 and an outlet 1005, a diaphragm 1007 adjacent the inlet 1003 and the outlet 1005 of the housing 1001, and an electroactive polymer (“EAP”) material 1009 coupled to the housing 1007. The diaphragm 1007 is positioned a distance from a base 1011 of the housing 1001 so that a fluid passage member or channel is defined by the diaphragm 1007 and an inner surface 1013 of the housing 1001. An inlet valve element 1015 is located at the inlet 1003 of the housing 1001 and an outlet valve element 1017 is located at the outlet 1005 of the housing 1001. The inlet and outlet valve elements 1015, 1017 may be configured to only allow fluid to flow in one direction, respectively. For example, the inlet valve element 1015 may only allow fluid to flow into the channel and the outlet valve element 1017 may only allow fluid to flow out of the channel. Additionally, the inlet and outlet valve elements 1015, 1017 may be opened by the pressure of a fluid flowing into the inlet and out of the outlet or the opening and closing of the inlet and outlet valves may be controlled by a controller.

The EAP material 1009 is configured to have an on-state, where the EAP material 1009 is energized, and an off-state, where the EAP material is not energized. In the embodiment shown in FIG. 10, the diaphragm 1007 comprises a dome spring and the EAP material 1009 is configured to compress the dome spring 1007 towards the inner surface 1013 of the housing 1001 when the EAP material 1009 is in the off-state and to allow the dome spring 1007 to return to its original shape when the EAP material 1009 is in the on-state. In another embodiment, the EAP material 1009 may be configured to compress the diaphragm when the EAP material 1009 is in the on-state and to avoid compression of the diaphragm 1007 when the EAP material 1009 is in the on-state.

The diaphragm is configured to at least partially cancel a stiffness of the EAP material 1009 with a negative spring rate mechanism. The diaphragm 1007 may comprise beams or other appropriately shaped and sized configurations may be used as the diaphragm 1007. Furthermore, the material of the diaphragm 1007 may be any appropriate elastic and resilient material, such as silicone polymer, at an appropriate thickness and an appropriate cross-sectional profile to accomplish the desired effect.

As described below with reference to present disclosure, part or all of one or more aspects of the methods and system, including the controller, discussed herein may be distributed as an article of manufacture that itself comprises a computer readable medium having computer readable code means embodied thereon.

Although the various embodiments of the systems, apparatus, and devices of the present disclosure have been described herein in connection with certain disclosed embodiments, many modifications and variations to those embodiments may be implemented. For example, different shapes of components may be employed. Also, where materials are disclosed for certain components, other materials may be used. The foregoing description and following claims are intended to cover all such modification and variations. The foregoing written description enables one of ordinary skill to make and use what is considered presently to be the best mode thereof, those of ordinary skill will understand and appreciate the existence of variations, combinations, and equivalents of the specific embodiment, method, and examples herein. The present disclosure should therefore not be limited by the above described embodiment, method, and examples, but by all embodiments and methods within the scope and spirit of the present disclosure as claimed.

Any patent, publication, or other disclosure material, in whole or in part, said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, said to be incorporated by reference herein, but which conflicts with existing definitions, statements, or other disclosure material set forth herein will only be incorporated to the extent that no conflict arises between that incorporated material and the existing disclosure material.

Various embodiments are described in the following numbered clauses.

1. A fluid flow device comprising a plurality of actuator members; an actuator backing structure, the plurality of actuator members attached to the actuator backing structure; a fluid passage member; a passage member backing structure, the fluid passage member attached to the passage member backing structure; wherein the plurality of actuator members are configured to compress the fluid passage member against the passage member backing structure.

2. The fluid flow device of clause 1, wherein the plurality of actuator members are configured to actuate in a first direction, and wherein the plurality of actuator members are configured to compress the fluid passage member against the backing structure in the first direction.

3. The fluid flow device of clause 1, wherein the fluid passage member comprises a flexible membrane and a delivery tube, wherein the flexible membrane is located between the plurality of actuator members and the delivery tube.

4. The fluid flow device of clause 3, further comprising at least one spring member coupled to the flexible membrane.

5. The fluid flow device of clause 1, wherein the actuator members are electroactive polymer actuators.

6. The fluid flow device of clause 5, wherein the electroactive polymer actuators are configured to compress the fluid passage member against the passage member backing structure according to a wave-shape configuration.

7. The fluid flow device of clause 1, further comprising a controller coupled to each of the plurality of actuator members, wherein the controller is configured to selectively activate each of the plurality of actuator members to force fluid through a portion of the fluid passage member.

8. The fluid flow device of clause 1, wherein the plurality of actuator members comprise a plurality of pre-strained actuators.

9. The fluid flow device of clause 1, wherein the fluid passage member has an inlet and an outlet, and wherein the plurality of actuator members are configured to move a fluid from the inlet to the outlet according to a wave-shape configuration.

10. The fluid flow device of clause 9, wherein the plurality of actuator members are configured to move the fluid from the inlet to the outlet according to the wave-shape configuration in a straight-line direction.

11. A fluid flow device comprising a housing having at least one aperture; an actuator element; a diaphragm located between the actuator element and at least one aperture of the housing; wherein the actuator element comprises an electroactive polymer material; wherein the electroactive polymer material is configured to compress the diaphragm adjacent the at least one aperture of the housing when the electroactive polymer material is in a first state.

12. The fluid flow device of clause 11, further comprising a focused compression component between the diaphragm and the actuator element.

13. The fluid flow device of clause 12, wherein the focused compression component has a ridge, wherein the ridge is configured compress the diaphragm against the at least one aperture of the housing.

14. The fluid flow device of clause 11, wherein the first state of the electroactive polymer material is an extended state, and wherein the electroactive polymer material is configured to allow the diaphragm to move away from the at least one aperture of the housing when the electroactive polymer material is in a contracted state.

15. The fluid flow device of clause 11, further comprising a controller coupled to the actuator element, wherein the controller is configured to selectively activate the electroactive polymer material of the actuator element to allow a fluid to pass through the at least one aperture of the housing.

16. The fluid flow device of clause 11, further comprising a preloading element, wherein the preloading element is configured to attach to the housing.

17. The fluid flow device of clause 15, wherein the preloading element is a compression cap.

18. The fluid flow device of clause 16, where the compression cap has a threaded configuration and the housing has a corresponding threaded configuration to receive the compression cap.

19. The fluid flow device of clause 17, wherein a force exerted by the actuator element to compress the diaphragm against the at least one aperture of the housing is adjustable based on the threaded configuration of the compression cap.

20. The fluid flow device of clause 15, further comprising an annular element, wherein the annular element is located between the preloading element and the diaphragm, and the annular element is located adjacent the actuator element.

21. The fluid flow device of clause 11, wherein at least one aperture is an inlet and the housing further comprises an outlet, wherein the housing further comprises an inlet valve element located at the inlet of the housing and an outlet valve element located at the outlet of the housing.

22. A fluid flow device comprising a housing having an inlet and outlet; a diaphragm located adjacent the inlet of the housing; an electroactive polymer material coupled to the housing, the electroactive polymer material having a first state and a second state; wherein the electroactive polymer material is configured to compress the diaphragm against the inlet of the housing when the electroactive polymer material is in the first state.

23. The fluid flow device of clause 22, wherein the electroactive polymer material is configured to avoid compression of the diaphragm against the inlet of the housing when the electroactive polymer material is in the second state.

24. The fluid flow device of clause 22, wherein the diaphragm comprises a negative spring rate mechanism.

25. The fluid flow device of clause 22, wherein the diaphragm comprises a dome spring.

26. The fluid flow device of clause 25, wherein the dome spring comprises a silicone polymer.

27. The fluid flow device of clause 22, wherein the inlet is a center port, and wherein the diaphragm is configured to be compressed against the center port when the electroactive polymer material is in the first state.

28. The fluid flow device of clause 22, wherein the diaphragm is located adjacent the outlet of the housing.

29. The fluid flow device of clause 22, further comprising an inlet valve element located at the inlet of the housing and an outlet valve element located at the outlet of the housing.

30. The fluid flow device of clause 22, wherein activation of the electroactive polymer facilitates fluid flow from the inlet to the outlet.

31. A fluid flow device comprising a backing structure; a compression element; and at least one actuator element adjacent the compression element; and wherein the at least one actuator element is configured to compress the compression element towards the backing structure when the at least one actuator element is in a first state; and wherein the at least one actuator element is configured to allow a fluid to flow from an inlet to an outlet of a fluid passage based on deflection of the at least one actuator element.

1. A fluid flow device comprising:
a backing structure;
a compression element; and
at least one actuator element adjacent the compression element; and
wherein the at least one actuator element is configured to compress the compression element towards the backing structure when the at least one actuator element is in a first state; and
wherein the at least one actuator element is configured to allow a fluid to flow from an inlet to an outlet of a fluid passage based on deflection of the at least one actuator element.

2. The fluid flow device of claim 1, wherein the backing structure comprises a passage member backing structure, wherein the compression element comprises the fluid passage, wherein the fluid passage comprises a fluid passage member, wherein the fluid passage member is attached to the passage member backing structure.

3. The fluid flow device of claim 2, further comprising an actuator backing structure, wherein the at least one actuator element is attached to the actuator backing structure.

4. The fluid flow device of claim 3, wherein the at least one actuator element comprises a plurality of actuator elements.

5. The fluid flow device of claim 4, wherein each of the plurality of actuator elements is configured to deflect in a first direction when each of the actuator elements is in the first state, and wherein each of the plurality of actuator members is configured to compress the fluid passage member against the passage backing structure in the first direction.

6. The fluid flow device of claim 4, further comprising a controller coupled to each of the plurality of actuator elements, wherein the controller is configured to selectively activate each of the plurality of actuator elements to force the fluid through a portion of the fluid passage member.

7. The fluid flow device of claim 1, wherein the backing structure comprises a housing having at least one aperture, wherein the housing comprises the fluid passage.

8. The fluid flow device of claim 7, and wherein the compression element comprises a diaphragm located between the at least one actuator element and at least one aperture of the housing, and wherein the at least one actuator element is configured to compress the diaphragm adjacent the at least one aperture of the housing to at least partially occlude the at least one aperture when the at least one actuator element is in the first state.

9. The fluid flow device of claim 8, further comprising a focused compression component between the diaphragm and the actuator member, wherein the focused compression component has a ridge, wherein the ridge is configured to compress the diaphragm against the at least one aperture of the housing.

10. The fluid flow device of claim 9, further comprising a preloading element, wherein the preloading element is configured to attach to the housing.

11. The fluid flow device of claim 1, wherein the at least one actuator element is at least one electroactive polymer transducer.

12. The fluid flow device of claim 11, wherein the at least one aperture of the housing comprises an inlet of the fluid passage, wherein the at least one electroactive polymer transducer is configured to compress the diaphragm against the inlet when the at least one electroactive polymer transducer is in the first state.

13. The fluid flow device of claim 12, wherein the at least one electroactive polymer transducer is configured to avoid compression of the diaphragm against the inlet of the housing when the at least one electroactive polymer material is in a second state.

14. The fluid flow device of claim 7, wherein the compression element comprises a negative spring rate mechanism.

15. The fluid flow device of claim 14, wherein the negative spring rate mechanism comprises a silicone polymer dome spring.

16. The fluid flow device of claim 7, wherein the compression element is configured to sealingly engage with the housing.

17. The fluid flow device of claim 10, wherein the preloading element is configured to sealingly engage with the housing via an annular element.
